(19) United States
(12) Patent Application Publication
(10) Pub. No.: US 2006/0136232 A1
(43) Pub. Date: Jun. 22, 2006

(54) Selection method for distributing options to target points

(76) Inventor: Hanno Scholtz, Zurich (CH)

Correspondence Address: EPSTEIN DRANGEL BAZERMAN & JAMES, LLP, 60 EAST 42ND STREET, SUITE 820, NEW YORK, NY, 10165, US

(21) Appl. No.: 10/536,707

(22) PCT Filed: Dec. 2, 2003
(86) PCT No.: PCT/CH03/00790

§ 371 Date: May 27, 2005

(30) Foreign Application Priority Data
Dec. 6, 2002 (CH) 2077/02

(51) Int. Cl. G06Q 99/00

(52) U.S. Cl. 705/1

(57) ABSTRACT

The information carriers 1 allocate confidence values 2 for which figures are exemplarily shown in FIG. 1 to sets of criteria 3 according to their preferences. In this respect, each information carrier 1 can allocate a certain number of confidence values 2. These sets of criteria are associated with options 4 wherein each option 4 can belong to several sets of criteria 3. Due to a selection procedure 5 which transfers the confidence values 2 to the options 4, the options 4 having the highest number of confidence values 2 are selected and allocated to the targets 7. These targets 7 form the panel 6. The work of the panel 6 leads to results 8. These results 8 are reevaluated by the information carriers 1. According to the satisfaction of the information carriers 1 with the results 8 the confidence values 2 can be newly allocated.

### TECHNICAL FIELD

The present invention relates to a procedure for the selection of options to be distributed to targets wherein each option belongs to one or more sets of criteria to achieve evaluable results.

### PRIOR ART

Selection procedures of this type are known since centuries, for example as a procedure for election into political office. An extract and a discussion of known election procedures are for example published in the publication “Die Ungerechtigkeit der Wahlverfahren” by Thomas Braun in the September 2002 issue of the journal “Spektrum der Wissenschaft” (pages 73-84). This publication discusses for example the difficulty of finding a mode of election which corresponds to the interests of the voting public. It must be particularly taken into consideration that the voters often vote tactically, i.e. they do not vote according to their wishes, but often want to go against a certain situation, to point the way. As soon as too many tactical voters point the way, however, it may happen that majorities are unintentionally formed which are in no way consistent with the opinion of the electorate. As described in the above-mentioned article, this problem has been repeatedly described in the literature; and up to now it is solved according to the state of the art by means of ad hoc-adjustments of the respective mode of election used.

It is only a special case of the general problem, however, that the knowledge of those concerned by the selection processes is only incompletely included. The voter knows various interest groups but can only support political parties. For example, the fund share owner reads in the newspaper about the positive development of an industrial sector. Since no specific fund is available for this he would have to buy individual shares on his own in order to benefit from his information.

### DESCRIPTION OF THE INVENTION

It is the object of the present invention to provide a selection procedure according to the main part of the main claim which utilizes the available information in a complete and direct way.

This object has been achieved by the characterizing features in claim 1.

### SHORT DESCRIPTION OF THE DRAWING

FIG. 1 Schematic representation of the procedure according to the invention.

### SHORT DESCRIPTION OF THE BEST MODE OF PRACTICING OF THE INVENTION

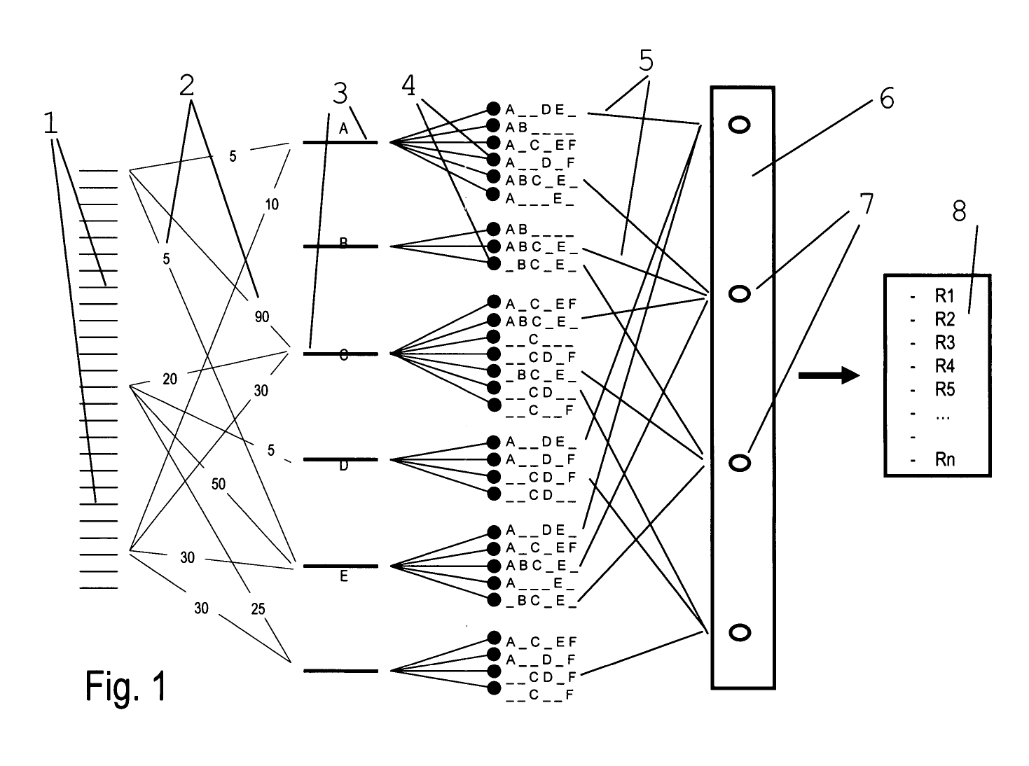

FIG. 1 schematically shows a diagram of the procedure according to the invention. The course is from left to right. The reference characters used in the drawing are described in a general manner in the list of reference terms and in more detail by means of two examples.

The information carriers 1 allocate confidence values 2 for which figures have been exemplarily listed in FIG. 1 to sets of criteria 3, here designated by A to F, according to their preferences. In this respect, each information carrier 1 can allocate a certain number of confidence values 2. These sets of criteria 3 are associated with options 4 wherein each option 4 can belong to several sets of criteria 3. The options are designated by the letter sequence representing their association with a set of criteria. For example, A_D_F means that this option 4 belongs to the sets of criteria A, D, and F, but not to B. C, and E. Due to a selection procedure 5 which transfers the confidence values 2 to the options 4, the options 4 having the highest number of confidence values 2 are chosen and allocated to the targets 7. These targets 7 form the panel 6. The work of the panel 6 leads to the results 8. These results 8 are reevaluated by the information carriers 1. Depending on the satisfaction of the information carriers 1 with the results 8 the confidence values 2 can be redistributed.

### MODES OF CARRYING OUT THE INVENTION

Options 4 refers to all objects such as goods, humans, animals, shares and conceptual terms which have many different properties, so-called criteria. Criteria of humans are for example the sex, age, school education, political opinion, human race, nationality, etc. Criteria of industrial goods are for example the material value, weight, the size dimensions, breaking strength during transport, the popularity, the manufacturer, country of origin, shelf life (especially in the case of foodstuffs), etc. It is obvious that each option 4 whether it is material, biological or conceptual can belong to many criteria at the same time and thus can belong to several sets of criteria simultaneously.

Targets 7 are all positions to be assigned. Particularly, this can be an investment fund of a bank or the positions in an administration or a government. Thus, targets 7 can for example be limited by their number, such as the positions in an administration, or by the asset value, such as in a share fund.

An assignment of these targets 7 entails certain consequences, the so-called results 8. These results 8 are for example the price course of a share fund, total revenue, asset, or per-capita income of a company, unemployment rate, the gross domestic product of a country, or the satisfaction of those concerned. Mostly the results 8 include of a whole list of results 8.

These results 8 are known to the so-called information carriers 1. Information carriers 1 are those persons who responsibly, although only indirectly, decide over the allocation of the options 4 to the targets 7. They exert their decision by applying their wishes. These wishes are allocated in the form of confidence values 2.

Information carriers 1 are for example investors of a bank which have participated in a share fund according to the invention. They have certain opinions about how this money should be invested. In the end, however, they do not decide which shares are sold or bought. They utter their wishes by allocating a number of confidence values 2, for example 100 confidence points per investment of an investment asset of CHF 1000, into sets of criteria 3. Thus, an investor could for example allocate 20 points for the set of criteria “Asian market”, 30 points in “shares in US dollars”, 40 points in “automotive industry”, and 10 points in “New Technology”. In this way, the share of Toyota Corp. would for example fall both under “Asia” and under “automotive”, that of Microsoft Corp. under “USD” and “New Technology”.

After each investor has allocated his confidence values 2, the sum of confidence values 2 in each set of criteria 3 can be evaluated. The confidence values 2 can have a fixed value, such as for example 100 points, per capital spent, i.e. for example per CHF 1000. In this way larger investors have a more profound vote than small investors.

Each set of criteria 3 is associated with a transfer function 5 of the confidence values 2 to the options 4 which belong to this set of criteria 3. These transfer functions 5 can be defined in different ways.

The simplest possibility would be the direct transfer of the confidence values 2 to each member of this group, i.e. to each individual option 4. In this manner, each option 4 obtains the same number of confidence values 2. For this purpose, the total number of confidence values 2 obtained can be for example divided by the number of options in this set of criteria 3. This is reasonable if this number of options 4 is a known and finite number. Another possibility is to transfer the total number of confidence values 2 received in their entirety or in a standardized form to the total number of confidence values 2 which have been allocated. This is reasonable where the total numbers of options in an unknown value, for example all shares available at one stock market in USD currency.

If for example “USD” receives 43,724 confidence values 2 with exactly the four registered shares “Microsoft”, “Ford”, “GE”, and “IBM” then each of these would receive 10,931 points. If, however, “USD” contains all shares in USD each of them would receive 43,724 confidence values 2. The transfer rules, however, must be the same for all sets of criteria 3 so that the weighting of the allocation of points remains unchanged.

On the other hand, the individual registered shares can also be given weighting factors by stock exchange specialists.

The following Examples will demonstrates these possibilities:

### EXAMPLE 1

The factors determined by stock exchange specialists relate to the expected development of a registered share. A registered share can for example be a share or an obligation. Thus, the individual confidence values 2 are stretched or compressed by success-evaluating factors allocated to the options 4. The registered shares can for example comprise Toyota, Samsung, KIA, etc. A transfer function 5 of this type results in the following confidence values 2 of the options 4:

| | | | confidence | confidence |
|---|---|---|---|---|
| | | | values of | values of |
| | | confidence | option | option |
| registered | | values of | (limited | (unlimited |
| shares | factor | set of | number of | number of |
| “Asia” | (weighting) | criteria | options) | options) |
| registered | 1.5 | 43,724 | 10,931 | 65,586 |
| share A1 | | | | |
| registered | 0.8 | 43,724 | 5,830 | 34,979 |
| share A2 | | | | |
| registered | 0.2 | 43,724 | 1,458 | 8,745 |
| share A3 | | | | |
| registered | 1.6 | 43,724 | 11,660 | 69,958 |
| share A4 | | | | |
| registered | 0.7 | 43,724 | 5,101 | 30,607 |
| share A5 | | | | |
| registered | 1.2 | 43,724 | 8,745 | 52,469 |
| share A6 | | | | |

### EXAMPLE 2

A disproportionate, in particular a logarithmic stretching or compression of the confidence values 2 could be performed. The transfer function 5 in this example is defined as follows:

For each share its expected annual profit is given in percent. From this, for example its natural logarithm increased by 1 is calculated. Multiplying this value with the confidence value 2 of the set of criteria 3 yields the calculated confidence value 2 of each of the options 4. Finally, the standardized confidence value 2 of an option 4 is calculated by division by the standard factor.

The standard factor corresponds to the natural logarithm increased by 1 of the profit which is on average expected for an “Asia” registered share, the so-called “standard expectation”.

| | ex- | | CV* of | calcu- | | stan- |
|---|---|---|---|---|---|---|
| registered | pected | | the set | lated CV* | stan- | dard- |
| share | profit | Nat. log | of | of the | dard | ized |
| “Asia” | r | ln(r + 1) | criteria | options | factor | CV* |
| standard | 4.6 | 1.723 | | | | |
| expectation | | | | | | |
| registered | 12.5 | 2.603 | 43,724 | 113,800 | 1.723 | 66,057 |
| share A1 | | | | | | |
| registered | 4.4 | 1.686 | 43,724 | 73,736 | 1.723 | 42,801 |
| share A2 | | | | | | |
| registered | 13.1 | 2.646 | 43,724 | 115,701 | 1.723 | 67,160 |
| share A3 | | | | | | |
| registered | 0.8 | 0.588 | 43,724 | 25,700 | 1.723 | 14,918 |
| share A4 | | | | | | |
| registered | 3.7 | 1.548 | 43,724 | 67,666 | 1.723 | 39,277 |
| share A5 | | | | | | |
| registered | 5.4 | 1.856 | 43,724 | 81,165 | 1.723 | 47,113 |
| share A6 | | | | | | |

*CV = confidence value

Any number of transfer functions 5 can be of course defined which calculate the transferred confidence values 2 of the individual options 4 from the confidence values 2 of a set of criteria 3. Standardization of the confidence values 2 of a set of criteria 3 can be performed by division by the total number of confidence values 2 allocated.

Particularly, also a further regional split up into Taiwan, Japan, South Korea can be considered. The transfer functions 5 are performed by those responsible for the actions to be taken, in this case by the bank.

The options 4, in this example the individual available registered shares or obligations, now collect confidence values 2 in all categories to which they belong. Finally, the sum of these confidence values 2 determines whether and to which extent a registered share becomes integrated in the investment fund. The exact key from the total score of confidence values 2 of an option 4 to its proportion within the investment fund is again performed by those responsible for the actions to be taken, in this case by the bank.

The result 8 in this example is the profit or the acquisition price of the investment fund, respectively. The investors to which this price is made available at any time can now compare its changes with the changes of other investment funds or with changes of stock exchange indices such as the NASDAQ, the Dow Jones, or the SPI. According to their own wishes, the investors, the information carriers, can reallocate the confidence values 2 at any time.

Another example according to the invention is the assignment of targets 7 in the form of positions in an administration or government panel. This panel 6 can be a municipal-authority, a governing board of a firm or a specialized commission within a company or a parliament or a parliament itself.

Available as the sets of criteria 3 are for example experience in particular specialized areas, the sex, age, school education, political opinion, human race, nationality, place of residence, or years of service of the options 4, in this case of the candidates.

The information carriers 1 are for example voters of a political community, for example members of a party or inhabitants of a country, or members of an association concerned with the commission, for example the parents electing the parents' council, the students electing the student representatives, the members of parliament electing a parliamentary investigating committee, or the employees electing a panel 6 for the investigation of the possibility of improved working conditions in a firm.

In this case, the results 8 would be the quality of the achievement of the predetermined aims of the panel 6. In policy, this means for example the political success of a government, for example expressed in a lowering of taxes, improved social conditions, a lower foreign debt rate, a lower crime rate, a higher gross domestic product, an improved infrastructure, etc. In a commission of specialists or in a party the results 8 must be established in accordance with the aims and interests of the information carriers 1, in this case the voters. In the case of the parents' council these can be the safety of the children on their way to school, for example by providing a pedestrian underpass under a road with heavy traffic, or in the case of students at a university an improved provision of information to new students with respect to individual issues such as examination requirements. In contrast to investment funds for example for which the results 8 focus on the financial development of the value of the investment fund the results 8 are split between a plurality of results 8 evaluated in retrospective by the information carriers 1, the voters.

The transfer functions 5 are also adapted to the criteria. For example the following factor allocation in the set of criteria “education” for candidates being the options 4 to be assigned to an administrative panel can be mentioned. This factor can be for example 0.5 for a completed apprenticeship, 1 for a school-leaving exam, 1.5 for a university degree, and 2 for a doctor's degree or another academic title.

In contrast to conventional elections by our known election procedures, the information carriers 1 can in this procedure according to the invention repeatedly alter the allocation of their confidence values 2 at any time or at defined time points.

Accordingly, the options 4 at the targets 7 can be exchanged continuously or at defined time points depending on the actual allocation of the confidence values 2. A prerequisite for this is that the information carriers 1 can continuously gather information about the actual assignment of the targets 7. The wishes can be adapted according to need depending on the satisfaction and/or changes of the actual conditions.

Specifically in large panels 6, such as internationally traded investment funds, or international organisations, such as the worldwide election of UNO council members, the use of linked computers is an absolute requirement. An implementation in another manner, for example by mail, would be too slow and thus not exact enough. The quick interactive change due to incidents arising, such as events related to war, local troubles, or new discoveries in a scientific area, often require immediate adaptations to the panels to the new needs. If it can be suddenly expected that for example the US dollar will become more interesting due to a lowering of taxes then a currency such as the USD will gain confidence values 2 within seconds, and respective shares should be purchased as soon as possible before the price has risen. This quick action requires the use of linked computers.

It can happen in the assignment of targets 7 that the confidence values 2 of the individual information carriers 1 shall not be combined simply in an additive manner. It can for example happen that a fund management is more interested in specialist information available only from a few information carriers 1. This results in the so-called highlighting effect. If the fund management compares two options 4 one of which, A, has been very strongly supported by a few information carriers 1 and the other, B, has experienced a weak support by many then it could wish that A gains a relative advantage in this case. The opposite is true in the case of elections where elected candidates 7 as options should be capable of representing as many voters 1 as possible. This is the so-called balancing effect. In this case, B would gain a relative advantage because support by the masses is provided.

In the procedure this can be achieved by performing a disproportionate, particularly logarithmic or exponential compression or stretching of the confidence values 2 allocated by the information carriers 1. By a disproportionate compression or stretching of this type prior to summing up the confidence values 2 within the sets of criteria 3 the desired effect is achieved.

The advantage of this procedure according to the invention is that the needs of the information carriers 1 can be uttered multi-dimensionally since the sets of criteria 3 get many different dimensions. Nevertheless, conventional election procedures, for example the proportional representation procedure of the canton council elections in Switzerland, allow for election of candidates from different parties. Thus, a voter who can for example vote for 25 candidates can allocate these votes to different parties. But it cannot be determined in addition that female candidates or candidates with an agricultural background shall be preferably considered. The reason for this is that a candidate belongs to one party only. In the present procedure, however, a candidate belongs to several sets of criteria.

### Reference List

| | General | Example: | Example: |
|---|---|---|---|
| Number | designation | Investment fund | Elections |
| 1 | information | investors | voters |
| | carriers | | club members |
| 2 | confidence | 20 (a figure) | 30 (a figure) |
| | value | | |
| 3 | set of | Asia | education |
| | criteria | USD | environmentally safe |
| | | New Technology | female sex |
| 4 | options | shares | candidates |
| | | obligations | members |
| 5 | selection | factors | factors |
| | transfer | functions | allocated values |
| | function | | |
| 6 | targets | purchased registered | political office |
| | | shares in fund | position in an |
| | | | administration |
| 7 | panel | investment fund | administration |
| | | | council |
| | | | commission |
| 8 | results | price | gross domestic public |
| | | profit | crime rate |
| | | | safety |
| | | | unemployment |
| | | | EBIT |

1. A procedure for the selection of options (4) to be allocated to targets (7) wherein each option (4) belongs to one or more sets of criteria (3) to achieve evaluable results (8) characterized in that
a. information carriers (1) allocate confidence values (2) to the sets of criteria (3);
b. all information carriers (1) can allocate an equal number of confidence values (2);
c. the sets of criteria (3) transfer confidence values (2) obtained to their options (4);
d. the options (4) are allocated to the targets (7) according to the confidence values (2) transferred to them.

2. The procedure according to claim 1 characterized in that the confidence values (2) transferred by the sets of criteria (3) to the options (4) are stretched or compressed by means of weighting factor of larger or smaller than 1 according to the correlation of the options (4) with the association of the sets of criteria (3).

3. The procedure according to claim 1 characterized in that the confidence values (2) allocated by the information carriers (1) are stretched or compressed prior to their summation in the sets of criteria (3).

4. The procedure according to claim 1 characterized in that the confidence values (2) transferred to the options (4) by the sets of criteria (3) are stretched or compressed by disproportionate, particularly logarithmic factors.

5. The procedure according to claim 1 characterized in that the information carriers (1) can repeatedly change the allocation of their confidence values (2) at any time or at defined time points.

6. The procedure according to claim 5 characterized in that the options (4) at the targets (7) can be exchanged continuously or at defined time points depending on the actual allocation of the confidence values (2).

7. The procedure according to claim 1 characterized in that the information carriers (1) can continuously gather information about the actual assignment of the targets (7).

8. The procedure according to claim 1 characterized in that the confidence values (2) are communicated by means of linked computers.
